(19) United States
(12) Patent Application Publication
(10) Pub. No.: US 2011/0149044 A1
(43) Pub. Date: Jun. 23, 2011

(54) IMAGE CORRECTION APPARATUS AND IMAGE CORRECTION METHOD USING THE SAME

(75) Inventor: Ho Chul SNIN, Daejeon (KR)

(73) Assignee: Electronics and Telecommunications Research Institute, Daejeon (KR)

(21) Appl. No.: 12/959,712

(22) Filed: Dec. 3, 2010

(30) Foreign Application Priority Data
Dec. 21, 2009 (KR) 10-2009-0127722

(51) Int. Cl. H04N 13/02; G06K 9/46; H04N 5/217; G06K 9/00; G06K 9/34

(52) U.S. Cl. 348/47; 382/190; 348/241; 382/154; 382/173; 382/167; 348/E13.074; 348/E05.024

(57) ABSTRACT

Provided is an image correction apparatus. The image correction apparatus includes an image input unit, a region extraction unit and an image correction unit. The image input unit generates a plurality of images, and performs a preprocessing operation on the plurality of generated images. The region extraction unit receives the preprocessed images, detects distance information from the image input unit to an object, presence information of the object and motion information of the object which are included in the images, and synthesizes the detected information to extract an ROI. The image correction unit corrects an image which corresponds to the extracted ROI. The image correction apparatus only corrects an image for a user's ROI, increasing efficiency of image correction.

### CROSS-REFERENCE TO RELATED APPLICATIONS

This application claims priority under 35 U.S.C. §119 to Korean Patent Application No. 10-2009-0127722, filed on Dec. 21, 2009, in the Korean Intellectual Property Office, the disclosure of which is incorporated herein by reference in its entirety.

### TECHNICAL FIELD

The following disclosure relates to an image correction apparatus and an image correction method using the same, and in particular, to an image correction apparatus and an image correction method using the same, which correct an image for a user's region of interest.

### BACKGROUND

An existing method, which corrects an image such as photograph and video, is manually performed using an image edition tool, for example, adobe photoshop and premiere. In the existing method for correcting image, for example, a user directly and manually corrects a dark portion of an image with the image edition tool.

As another existing method for correcting image, there is a method that automatically corrects an image which is displayed on a screen according to an external image environment such as external lighting or natural light.

In the existing method for manually correcting image, however, much time is taken by user's correcting an image manually. The existing method for automatically correcting image does not propose a scheme that corrects an image for a region desired by a user, i.e., a region of interest.

### SUMMARY

In one general aspect, an image correction apparatus includes: an image input unit generating a plurality of images, and performing a preprocessing operation on the plurality of generated images; a region extraction unit receiving the preprocessed images, detecting distance information from the image input unit to an object, presence information of the object and motion information of the object which are included in the images, and synthesizing the detected information to extract a Region Of Interest (ROI); and an image correction unit correcting an image which corresponds to the extracted ROI.

In another general aspect, an image correction method includes: performing a preprocessing operation on a plurality of images which are acquired from a plurality of camera modules, respectively; detecting distance information from the plurality of preprocessed images to an object, presence information of the object and motion information of the object, and synthesizing the detected information to extract an ROI of a user; and correcting an image which corresponds to the extracted ROI.

Other features and aspects will be apparent from the following detailed description, the drawings, and the claims.

### BRIEF DESCRIPTION OF THE DRAWINGS

FIG. 1 is an entire block diagram illustrating an image correction apparatus according to an exemplary embodiment.

FIG. 2 is a block diagram illustrating a configuration external to each element which is included in the image correction apparatus of FIG. 1.

FIG. 3 is a flowchart illustrating an image correction method using the image correction apparatus of FIG. 1.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

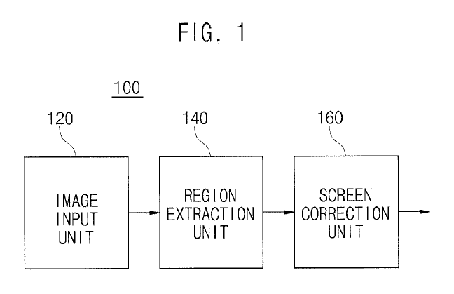

FIG. 1 is an entire block diagram illustrating an image correction apparatus according to an exemplary embodiment.

Referring to FIG. 1, an image correction apparatus according to an exemplary embodiment largely includes an image input unit 120, a region extraction unit 140, and a screen correction unit 160.

The image input unit 120 performs a preprocessing operation on images that are acquired from a plurality of camera modules.

The region extraction unit 140 detects distance information from the plurality of preprocessed images to an object and the presence information and motion information of the object, and synthesizes the detected information to extract a user's Region Of Interest (ROI). The following description will be made on the assumption of that the object is a person.

The image correction unit 160 corrects an image corresponding to the extracted ROI.

The image correction apparatus 100 according to an exemplary embodiment synthesizes distance to the object and the presence information and motion information of the object to extract various ROIs based on the user's interest. Subsequently, images are corrected for the extracted various ROIs.

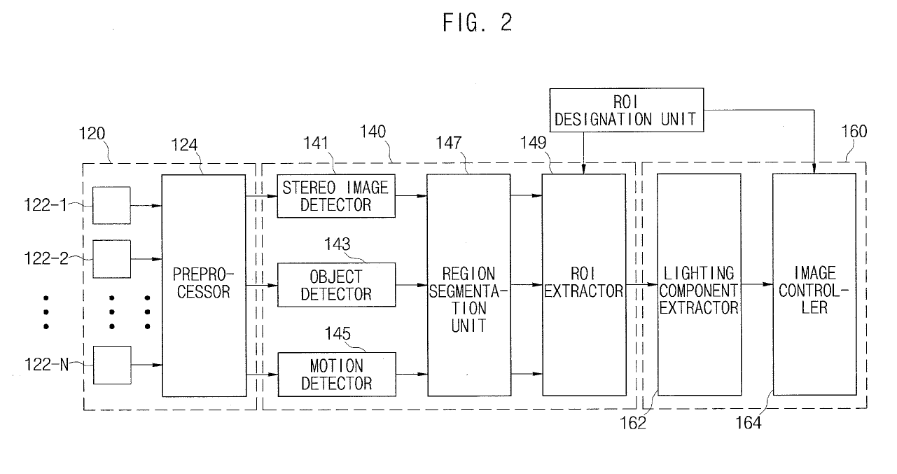

FIG. 2 is a block diagram illustrating a configuration external to each element which is included in the image correction apparatus of FIG. 1.

Referring to FIG. 2, the image input unit 120 performs a preprocessing operation on images that are acquired from a plurality of cameras. For this, the image input unit 120 includes a plurality of camera modules 122-1 to 122-N (where N is a natural number) that are arranged in parallel with the object, and a preprocessor 124 receiving a plurality of images that are transferred from the camera modules 122-1 to 122-N. The preprocessor 124 removes noises included in the plurality of images and performs a preprocessing operation for synchronizing the images.

Hereinafter, the image extraction unit 140 of FIG. 1 will be described in detail.

The region extraction unit 140 detects distance information from the plurality of preprocessed images to an object, the presence information and motion information of the object, and synthesizes the detected information to extract the user's ROI. For this, the image extraction unit 140 includes a stereo image detector 141, an object detector 143, a motion detector 145, a region segmentation unit 147, and an ROI extractor 149.

The elements of the image extraction unit 140 will be described in detail below.

The stereo image detector 141 receives a plurality of images to generate stereo images including distance information. That is, the stereo image detector 141 calculates a disparity between images that are received from the camera modules 122-1 to 122-N, calculates distance information for each position in the images, and detects the stereo images including the calculated distance information.

The object detector 143 detects information such as the edge of a person region and the face pattern and skin color of the person region and detects object presence information indicating whether an object exists in an image and the location of the object region on the basis of the detected information, through various object detection algorithms for detecting an object (hereinafter referred to as a person) included in an image.

The motion detector 145 detects a motion image including motion information, which indicates whether the motion of a person exists in an image and the location of the motion region, using a difference value between the previous image of a previous image frame and the current image of a current image frame. In another method, the motion detector 145 detects the motion information in an image on the basis of vector information such as a motion vector that occurs in the encoding of a moving image.

Subsequently, the region segmentation unit 147 receives a stereo image including distance information, motion information and object presence information including a person and segments a region in each image. For example, the region segmentation unit 147 segments a foreground region and a background region in an image by using the stereo image including distance information, and segments the presence region and non-presence region of a person in an image on the basis of the object presence information. Moreover, the region segmentation unit 147 segments a motion region and a non-motion region in an image on the basis of the motion information.

The ROI extractor 149 extracts the user's ROI from among the regions that are segmented by the region segmentation unit 147, on the basis of input information that is designated in an ROI designation unit 10. As an example, the ROI region may be extracted through the ROI extractor 149 by variously synthesizing an object that includes all moving persons or things within a designated distance, an object that includes all non-moving persons or things far away from the designated distance, all persons within the designated distance, non-moving persons among all persons in a screen and all moving things other than a person, according to the user's interest. The ROI designation unit 10 serves as a kind of interface that receives information designated by the user.

In this way, the ROI that is extracted through various synthesis by the region extractor 140 is transferred to the image correction unit 160, and thereby an image corresponding to the ROI is corrected.

Hereinafter, the image correction unit 160 will be described in detail.

The image correction unit 160 includes a lighting component extractor 162 and an image controller 164, for correcting an image corresponding to the ROI that has been extracted through various synthesis.

The lighting component extractor 162 extracts the lighting component of an image corresponding to the ROI. That is, the lighting component extractor 162 extracts a lighting component such as the gray scale value of the each pixel of the image corresponding to the ROI.

The image controller 164 controls the extracted lighting component and corrects the image of the ROI that is designated by the ROI designation unit 10. For example, the image controller 164 may control the gray scale value of only a near person or thing in an image and brightly correct the image. Alternatively, the image controller 164 corrects the image in various schemes that emphasize a near moving person in specific color or delete a far non-moving person or thing.

In this way, the image corrected by the image correction unit 160 may be transferred to various application processing devices for processing images and be applied.

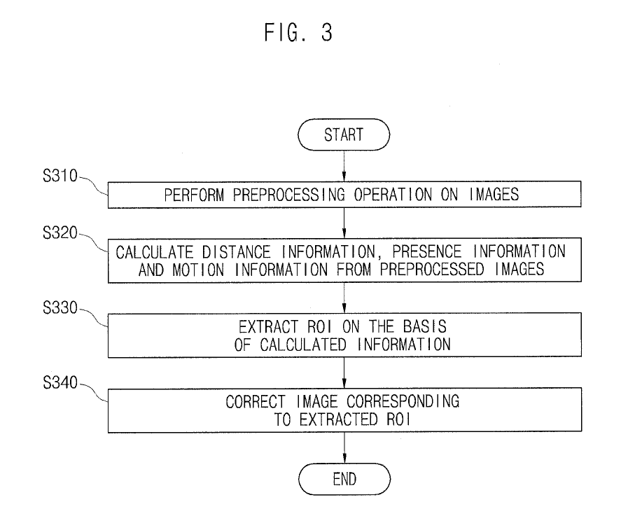

FIG. 3 is a flowchart illustrating an image correction method using the image correction apparatus of FIG. 1.

Referring to FIG. 3, the image correction apparatus 100 performs a preprocessing operation on images that are acquired from a plurality of camera modules in operation S310. The preprocessing operation removes noises included in a plurality of images and synchronizes the images.

The image correction apparatus 100 calculates distance information from the plurality of preprocessed image to an object and the presence information and motion information of the object in operation S320, and extracts a user's ROI on the basis of the calculated information in operation S330.

The image correction apparatus 100 corrects an image for the extracted ROI in operation S340.

As described above, the image correction apparatus and method according to an exemplary embodiment synthesizes distance from a camera module to an object, the presence and location of a person and motion to extract various ROIs. The image correction apparatus and method may correct an image in various correction schemes that brightly and gorgeously correct only a near thing in a screen for the ROI, emphasizes a near moving person in specific color, and deletes a far non-moving thing.

In the photograph and video of the related art, a background is bright, only a person region is dark, or a third party or a person is not accurately seen. On the other hand, in an exemplary embodiment, the object detector and the stereo image detector extract a third party or person region, and the image correction unit makes the background of the extracted region dark and selectively corrects only the third party or person region brightly and gorgeously.

When the image correction apparatus and method according to an exemplary embodiment are applied to a security system, the security system may detect a region having motion, a region having no motion and the motion of an undesired background. Through this, the security system may perform image correction such as that it increases the brightness of an important region and emphasizes the color of the important region, thereby improving the quality of an image acquired by a security camera.

When photographing an image that is included in a movie or a music video, in an exemplary embodiment, the object detector and the stereo image detector make a background dark even without separate lighting and make a character bright and gorgeous. Accordingly, the image correction apparatus and method can provide various image effects.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An image correction apparatus, comprising:
an image input unit generating a plurality of images, and performing a preprocessing operation on the plurality of generated images;
a region extraction unit receiving the preprocessed images, detecting distance information from the image input unit to an object, presence information of the object and motion information of the object which are comprised in the images, and synthesizing the detected information to extract a Region Of Interest (ROI); and
an image correction unit correcting an image which corresponds to the extracted ROI.

2. The image correction apparatus of claim 1, wherein the image input unit comprises:
a plurality of camera modules generating the plurality of images which comprise an object; and
a preprocessor removing noises of the generated images, and synchronizing the images.

3. The image correction apparatus of claim 1, wherein the region extraction unit comprises:
a stereo image detector generating a stereo image which comprises the distance information, by using a disparity between the preprocessed images;
an object detector detecting object presence information, which indicates presence of the object, from the preprocessed images through an object detection algorithm;
a motion detector detecting motion information of the object in an image by using a difference value between a previous image of a previous image frame and a current image of a current image frame among the preprocessed images;
a region segmentation unit segmenting a foreground region and a background region in the stereo image on the basis of the distance information, and segmenting a presence region of the object and a non-presence region comprising no object of the object in the object image, and segmenting a motion region and a non-motion region in the motion image; and
an ROI extractor extracting a user's ROI from among the regions which are segmented by the region segmentation unit, on the basis of input information which is designated by the user.

4. The image correction apparatus of claim 3, wherein the motion detector detects a motion image comprising the motion information of the object in an image by using a motion vector which occurs in encoding of a moving image.

5. The image correction apparatus of claim 3, wherein the ROI extractor extracts an ROI comprising a moving object within a designated distance, an ROI comprising a non-moving object far away from the designated distance, an ROI comprising a non-moving object within the designated distance and an ROI comprising all moving objects, on the basis of the designated input information.

6. The image correction apparatus of claim 5, further comprising: an ROI designation unit performing an interface function, and transferring the input information designated by the user to the ROI extractor.

7. The image correction apparatus of claim 1, wherein the image correction unit comprises:
a lighting component extractor extracting gray scale values of pixels, which are comprised in an image corresponding to the extracted ROI, as lighting components; and
an image controller controlling the gray scale values to correct the image corresponding to the ROI.

8. An image correction method, comprising:
performing a preprocessing operation on a plurality of images which are acquired from a plurality of camera modules, respectively;
detecting distance information from the plurality of preprocessed images to an object, presence information of the object and motion information of the object, and synthesizing the detected information to extract a Region Of Interest (ROI) of a user; and
correcting an image which corresponds to the extracted ROI.

9. The image correction method of claim 8, wherein the extracting of an ROI comprises:
detecting a stereo image which comprises the distance information, by using a disparity between the preprocessed images;
detecting object presence information, which indicates presence of the object, from the preprocessed images through an object detection algorithm;
detecting motion information of the object by using a difference value between an image of a previous frame and a image of a current frame among the preprocessed images; and
segmenting the image on the basis of the detected information.

10. The image correction method of claim 9, wherein the segmenting of the image comprises:
segmenting a foreground region and a background region which are comprised in the plurality of images by using the detected stereo image;
segmenting a region comprising object and a region comprising no object which are comprised in the plurality of images on the basis of the detected object presence information; and
segmenting a region having motion of the object and a region having no motion of the object which are comprised in the plurality of images on the basis of the detected motion information.

11. The image correction method of claim 10, wherein the extracting of an ROI synthesizes the segmented regions to extract the ROI according to interest of the user.

12. The image correction method of claim 9, wherein the detecting of object presence information detects the object presence information which comprises edge information of the object, shape pattern information of the object and skin color information of the object through the object detection algorithm.

13. The image correction method of claim 12, wherein the object is a person.

14. The image correction method of claim 9, wherein the ROI comprises a region comprising a moving object within a designated distance, a region comprising a non-moving object far away from the designated distance, a region comprising a non-moving object within the designated distance and a region comprising all moving objects, on the basis of the designated input information.

15. The image correction method of claim 13, wherein the correcting of an image comprises:
extracting gray scale values of pixels, which are comprised in an image corresponding to the extracted ROI, as lighting components; and
controlling the gray scale values to correct the image corresponding to the ROI.
